(19) United States
(12) Patent Application Publication
(10) Pub. No.: US 2021/0073480 A1
(43) Pub. Date: Mar. 11, 2021

(54) AUTOMATIC PREPROCESSING FOR BLACK BOX TRANSLATION

(71) Applicant: NETFLIX, INC., Los Gatos, CA (US)

(72) Inventors: Sneha MEHTA, Falls Church, CA (US); Ballav BIHANI, Fremont, CA (US); Victoria BONACI, Redwood City, CA (US); Boris Anthony CHEN, Palo Alto, CA (US); Ritwik Kailash KUMAR, Los Gatos, CA (US); Vinith MISRA, Cupertino, CA (US); Avneesh Singh SALUJA, Santa Monica, CA (US); Marianna SEMENIAKIN, San Jose, CA (US)

(21) Appl. No.: 17/011,960

(22) Filed: Sep. 3, 2020

Related U.S. Application Data
(60) Provisional application No. 62/896,552, filed on Sep. 5, 2019.

(51) Int. Cl. G06F 40/58

(52) U.S. Cl. CPC G06F 40/58

(57) ABSTRACT

Various embodiments set forth systems and techniques for training a sentence preprocessing model. The techniques include determining, using a machine translation system, a back translation associated with a ground truth translation of a source sentence in a source language to a target language, wherein the back translation comprises a translation of the ground truth translation from one or more target languages to the source language; determining, using the sentence preprocessing model, a simplified sentence associated with the source sentence; and updating one or more parameters of the sentence preprocessing model based on the simplified sentence and the back translation.

### CROSS-REFERENCE TO RELATED APPLICATIONS

This application claims priority benefit of the United States Provisional Patent Application titled, “AUTOMATIC PREPROCESSING FOR BLACK-BOX TRANSLATION,” filed on Sep. 5, 2019 and having Ser. No. 62/896,552. The subject matter of this related application is hereby incorporated herein by reference.

### BACKGROUND

### Field of the Various Embodiments

The various embodiments relate generally to computer science and machine translation systems and, more specifically, to a method for automatic preprocessing for black box translation.

### Description of the Related Art

Machine translation systems use various approaches to advance the state and quality of machine translation. Some systems use a sequence transduction approach to map input text sequences in a source language to translated text sequences in a target language. Unsupervised or semi-supervised approaches to machine translation are also gaining in popularity and typically leverage bitexts composed of both source language and target language versions of texts when training.

During training, many machine translation systems generally rely on the availability of large-scale parallel corpora, which include larger collections of parallel data composed of original text and the corresponding translations. Parallel corpora for certain language pairs are readily available, such as parallel corpora for high resource language pairs with larger training sets, large scale parallel data, or the like. The availability of large-scale parallel corpora for high resource language pairs has enabled machine translation systems to achieve state-of-the-art performance. However, achieving state-of-the-art translation performance for low resource language pairs with smaller training sets, scarce parallel data, or the like, remains a challenge.

A wide range of applications that rely on machine translation use black box machine translation systems. Black box machine translation systems include any machine learning model which has been trained and tuned a priori. Often, there is limited or no access to the model parameters or training data for fine-tuning or improving black box machine translation systems. As a result, black box machine translation systems are hard to adapt, tune to a specific domain, or build upon. While some black box machine translation systems provide the option of fine-tuning on domain-specific data under certain conditions, improving the performance of such black box machine translation systems on domain-specific translation tasks or for low resource language pairs is difficult and results in suboptimal translation performance.

In addition, black box machine translation systems tend to incorrectly translate complex idiomatic and non-compositional phrases such as sentences containing phrases, idioms, complex words, or the like. This problem is prevalent even when black box machine translation systems are fine-tuned on domain-specific data, such as specific types of data (e.g., descriptive text, conversational dialogues, spoken language, or the like), data with similar underlying properties, or the like. In particular, black box machine translation systems, like other machine translation systems, are not robust across different domains of data and tend to perform poorly when translating text having underlying properties that differ from those used to train the system. The problem is exacerbated when dealing with low resource language pairs because the paucity of data does not allow the machine translation system to infer the translations of the myriad of phrases and complex words.

To solve this problem, certain prior art machine translation systems use simplification models, such as automatic text simplification systems or the like, to simplify complex idiomatic and non-compositional phrases. Such simplification models typically transform original texts into their lexically and syntactically simpler variants. However, most simplification models operate only on the sentence level, and do not simplify texts at the discourse level. In addition, such systems tend to be modular, rule-based, and limited to specific domains or languages.

Further, in the context of domain-specific translation, determining what training data is best suited to train such simplification models is difficult. In particular, open source datasets may contain data related to descriptive text, which may not be appropriate for training simplification models for other domains such as conversational dialogues or the like. Collecting a large amount of domain-specific simplification data tends to be prohibitive, thereby limiting options when constructing simplification models. Accordingly, existing simplification models are limited by the availability of parallel simplification corpora, and tend to be domain specific.

Accordingly, there is a need for techniques for improving the performance of black box machine translation systems in the translation of complex idiomatic and non-compositional phrases, especially in the context of low resource language pairs. In addition, there is a need for techniques for efficiently generating parallel corpora for training simplification models to adapt to new domains.

### SUMMARY

One embodiment of the present invention sets forth a computer-implemented method for training a sentence preprocessing model, the method comprising determining, using a machine translation system, a back translation associated with a ground truth translation of a source sentence in a source language to a target language, wherein the back translation comprises a translation of the ground truth translation from one or more target languages to the source language; determining, using the sentence preprocessing model, a simplified sentence associated with the source sentence; and updating one or more parameters of the sentence preprocessing model based on the simplified sentence and the back translation.

Disclosed techniques allow for easily adapting a simplification model to a new domain by efficiently generating training data that includes large-scale parallel corpora based on back translations derived from high resource language pairs in that domain. The trained simplification model achieves improved performance in simplifying complex idiomatic and non-compositional phrases in low resource language pairs prior to translation by black box machine translation systems, thereby resulting in improved translation performance for low resource language pairs while preserving the meaning of the original sentences.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating a computing system configured to implement one or more aspects of the present disclosure.

FIG. 2 is a more detailed illustration of the training engine and testing engine of FIG. 1, according to various embodiments of the present disclosure.

FIG. 3 is a flowchart of method steps for a sentence preprocessing procedure performed by the training engine and testing engine of FIG. 1, according to various embodiments of the present disclosure.

FIG. 4 is a flowchart of method steps for a sentence translation procedure, according to various embodiments of the present disclosure.

FIG. 5 illustrates a network infrastructure used to distribute content to content servers and endpoint devices, according to various embodiments of the present disclosure.

FIG. 6 is a block diagram of a content server that may be implemented in conjunction with the network infrastructure of FIG. 5, according to various embodiments of the present disclosure.

FIG. 7 is a block diagram of a control server that may be implemented in conjunction with the network infrastructure of FIG. 5, according to various embodiments of the present disclosure.

FIG. 8 is a block diagram of an endpoint device that may be implemented in conjunction with the network infrastructure of FIG. 5, according to various embodiments of the present disclosure.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

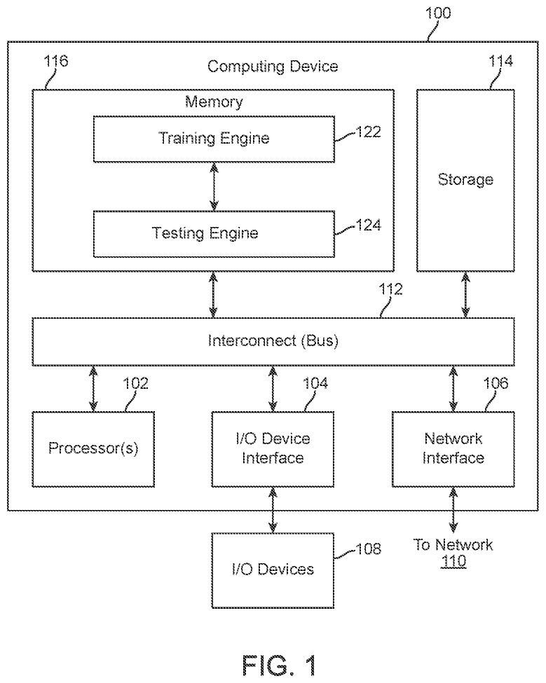

FIG. 1 illustrates a computing device 100 configured to implement one or more aspects of the present disclosure. As shown, computing device 100 includes an interconnect (bus) 112 that connects one or more processor(s) 102, an input/output (I/O) device interface 104 coupled to one or more input/output (I/O) devices 108, memory 116, a storage 114, and a network interface 106.

Computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 described herein is illustrative and that any other technically feasible configurations fall within the scope of the present disclosure.

Processor(s) 102 includes any suitable processor implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O device interface 104 enables communication of I/O devices 108 with processor(s) 102. I/O device interface 104 generally includes the requisite logic for interpreting addresses corresponding to I/O devices 108 that are generated by processor(s) 102. I/O device interface 104 may also be configured to implement handshaking between processor(s) 102 and I/O devices 108, and/or generate interrupts associated with I/O devices 108. I/O device interface 104 may be implemented as any technically feasible CPU, ASIC, FPGA, any other type of processing unit or device.

In one embodiment, I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 includes any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

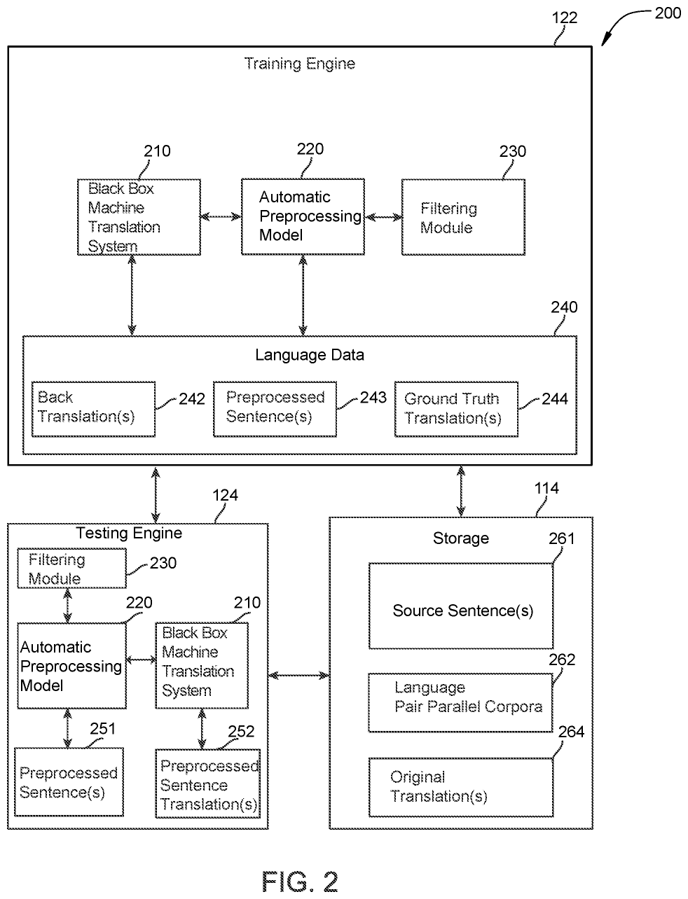

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and testing engine 124. Training engine 122 and testing engine 124 are described in further detail below with respect to FIG. 2.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and testing engine 124 may be stored in storage 114 and loaded into memory 116 when executed.

FIG. 2 is a more detailed illustration of training engine 122 and testing engine 124 of FIG. 1, according to various embodiments of the present disclosure. As shown, training engine 122 includes, without limitation, black box machine translation system 210, automatic preprocessing model 220, filtering module 230, and/or language data 240.

Black box machine translation system 210 includes any technically feasible machine translation system, natural language processing model, or the like. In some embodiments, black box machine translation system 210 includes one or more types of machine translation systems such as rule-based machine translation systems, hybrid machine translation systems, corpus-based machine translation systems, statistical machine translation systems, neural machine translation systems, example-based machine translation system, phrase-based machine translation system, or the like. In some embodiments, black box machine translation system 210 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), self-organizing maps (SOMs), Transformers, and/or other types of artificial neural networks or components of artificial neural networks.

In some embodiments, black box machine translation system 210 includes functionality to perform supervised learning, unsupervised learning, semi-supervised learning (e.g., supervised pre-training followed by unsupervised fine-tuning, unsupervised pre-training followed by supervised fine-tuning, or the like), cross-lingual transfer learning (e.g., transfer of models or annotations between languages, cross-lingual sentence embeddings, or the like), self-supervised learning, or the like. In some embodiments, unsupervised learning includes unsupervised feature induction, such as unsupervised dependency parsing, brown clustering, unsupervised POS tagging, word vectors methods, or the like. In some embodiments, black box machine translation system 210 includes any machine learning model which has been trained and tuned a priori. In some embodiments, there is limited or no access to the model parameters or training data for fine-tuning or improving black box machine translation system 210.

In some embodiments, black box machine translation system 210 is customized for a specific domain, customized for a combination of domains, adaptable to multiple domains, or the like. Domains include specific types of data (e.g., descriptive text, conversational dialogues, spoken language, or the like), specific field (e.g., weather data, medical data, legal data, or the like), data with similar underlying properties, or the like.

Automatic preprocessing model 220 includes any technically feasible text simplification system, text processing system, or the like. In some embodiments, automatic preprocessing model 220 converts original text such as source sentence(s) 261, back translation(s) 242, or the like into a simplified text such as preprocessed sentence(s) 243 or the like. In some embodiments, simplified text includes paraphrased text, lexically simpler variant of original text, syntactically simpler variant of original text, text with simpler sentence structure, text with reduced ambiguity, or the like. In some embodiments, automatic preprocessing model 220 is configured to simplify one or more texts at the character level, word level, sentence level, phrase-level, discourse level, or the like.

In some embodiments, automatic preprocessing model 220 includes one or more sequence-to-sequence models, or the like. In some embodiments, automatic preprocessing model 220 includes one or more systems configured to convert one or more sequences (e.g., text sequences, word sequences, or the like) from one language, domain, or the like to one or more sequences in another language, domain, or the like. In some embodiments, automatic preprocessing model 220 includes one or more systems configured to perform one or more text processing tasks such as parsing, information retrieval, summarization, or the like. In some embodiments, automatic preprocessing model 220 includes any system configured to improve the performance of black box machine translation system 210 such as improving fluency of translation output, reducing technical post-editing effort, or the like.

In some embodiments, automatic preprocessing model 220 includes recurrent neural networks (RNNs), convolutional neural networks (CNNs), deep neural networks (DNNs), deep convolutional networks (DCNs), deep belief networks (DBNs), restricted Boltzmann machines (RBMs), long-short-term memory (LSTM) units, gated recurrent units (GRUs), generative adversarial networks (GANs), self-organizing maps (SOMs), Transformers, and/or other types of artificial neural networks or components of artificial neural networks. In some embodiments, automatic preprocessing model 220 includes functionality to perform supervised learning, unsupervised learning, semi-supervised learning (e.g., supervised pre-training followed by unsupervised fine-tuning, unsupervised pre-training followed by supervised fine-tuning, or the like), cross-lingual transfer learning (e.g., transfer of models or annotations between languages, cross-lingual sentence embeddings, or the like), self-supervised learning, or the like.

Filtering module 230 includes functionality to evaluate the output of black box machine translation system 210, automatic preprocessing model 220, or the like. In some embodiments, filtering module 230 includes functionality to allow for human evaluation of translation quality (e.g., functionality to allow a user to score the quality each translation on a scale of 1-5, functionality to allow a user to compare the relative quality of translations, functionality to allow a user to pick one or more translations among multiple translations based on an analysis of the translation quality, or the like). In some embodiments, filtering module 230 includes one or more algorithms configured to implement one or more metrics associated with translation quality such as BLEU (bilingual evaluation understudy), NIST (national institute of standards and technology), METEOR (metric for evaluation of translation with explicit ordering), GLEU (Google BLEU), WER (word error rate), ROUGE (recall-oriented understudy for gisting evaluation), TER (translation edit rate), or the like. In one instance, the algorithm is configured to compare a candidate text (e.g., text associated with back translation(s) 242 or the like) to one or more reference texts (e.g., source sentence(s) 261, ground truth translation(s) 244, or the like). In another instance, the algorithm is configured to assign a score associated with the overall quality of the translation or the like. In some embodiments, the algorithm is configured to assign a score to one or more segments of the candidate text, one or more n-grams (e.g., word sequences in the candidate text, or the like), alignment between one or more sequences in the candidate text and the reference text, or the like. The algorithm then determines a statistical measure such as mean values, standard deviation, range of values, median values, and/or the like based on the combination of the scores assigned to the one or more segments. In some embodiments, filtering module 230 includes a user interface that provides interactive functionality for receiving user input such as user assessment of translation quality or the like.

In some embodiments, filtering module 230 includes one or more algorithms configured to implement one or more metrics associated with quality of simplification of a text such as SARI (system output against references and against the normal sentence), BLEU (bilingual evaluation understudy), or the like. In one instance, the algorithm is configured to compare a candidate text (e.g., text associated with preprocessed sentence(s) 243 or the like) to one or more reference texts (e.g., source sentence(s) 261, back translation(s) 242, reference simplification data, or the like). In another instance, the algorithm is configured to assign a score associated with the overall quality of the simplification, or the like. In some embodiments, the algorithm is configured to assign a score to one or more segments of the candidate text, one or more n-grams (e.g., word sequences in the candidate text, or the like), alignment between one or more sequences in the candidate text and the reference text, or the like. The algorithm then determines a statistical measure such as mean values, standard deviation, range of values, median values, and/or the like based on the combination of the scores assigned to the one or more segments. In some embodiments, filtering module 230 includes a user interface that provides interactive functionality for receiving user input such as user assessment of simplification quality or the like.

Language data 240 includes any data associated with one or more languages. In some embodiments, language data is associated with one or more high resource languages (e.g., language with large amounts of training data from various domains, many lexical, semantic, or syntactic resources, or the like), one or more low resource languages (e.g., language with limited amounts of training data from various domains, few lexical, semantic, or syntactic resources, or the like), one or more high-resource language pairs, one or more low resource language pairs, or the like. Language data 240 includes, without limitation, back translation(s) 242, preprocessed sentence(s) 243, and ground truth translation(s) 244.

Back translation(s) 242 includes text obtained by using black box machine translation system 210 to translate ground truth translation(s) 244 from a target language (e.g., Welsh, Quechua, Swahili, Punjabi, or the like) back to the source language (e.g., English or the like). In some embodiments, a back translation 242 includes a synthetically-generated version of a source sentence 261 derived from translating any translation (e.g., original translation 264) in a target language (e.g., French, Spanish, Portuguese, or the like) back to the source language (e.g., English or the like). In some embodiments, a given source sentence 261 can have multiple back translation(s) 242 associated with multiple target languages, with each back translation derived from a different ground truth translation in a corresponding target language.

Preprocessed sentence(s) 243 includes text corresponding to a preprocessed version of source sentence(s) 261 derived from back translation(s) 242. In some embodiments, preprocessed sentence(s) 243 includes paraphrased text, lexically simpler variant of original text, syntactically simpler variant of original text, text with simpler sentence structure, text with reduced ambiguity, or the like corresponding to source sentence(s) 261. In some embodiments, preprocessed sentence(s) 243 includes multiple simplifications for a given source sentence 261 or the like.

Ground truth translation(s) 244 includes any text associated with good quality translation of source sentence(s) 261, such as professional human translation, or the like. In some embodiments, ground truth translation(s) 244 include text associated with one or more ideal or expected translations of source sentence(s) 261. In some embodiments, ground truth translation(s) 244 includes text that meets one or more predetermined threshold criteria based on one or more metrics associated with translation quality such as BLEU (bilingual evaluation understudy), NIST (national institute of standards and technology), METEOR (metric for evaluation of translation with explicit ordering), GLEU (Google-BLEU), WER (word error rate), ROUGE (recall-oriented understudy for gisting evaluation), TER (translation edit rate), or the like. In some embodiments, ground truth translation(s) 244 includes multiple reference translations for a given source sentence 261 or the like. In some embodiments, ground truth translation(s) 244 includes data derived from one or more text datasets or the like.

Storage 114 includes, without limitation, source sentence(s) 261, language pair parallel corpora 262, and/or original translation(s) 264. Source sentence(s) 261 includes any combination of one or more words, phrases, sentences, paragraphs, text strings, or the like in a source language. In some embodiments, source sentence(s) 261 include one or more complex, idiomatic, or non-compositional phrases. In some embodiments, source sentence(s) 261 include one or more sentence(s) in one or more domains such as movie subtitles, tv subtitles, descriptive text, conversational dialogues, spoken language, weather data, medical data, legal data, or the like. In some embodiments, source sentence(s) 261 includes one or more sentences derived from one or more text datasets or the like.

Language pair parallel corpora 262 includes one or more collections of parallel data composed of original text and the corresponding translations for one or more language pairs. Each language pair includes a source language and a target language. In some embodiments, language pair parallel corpora 262 includes corpora for one or more low resource language pairs (e.g., English-Hungarian (En-Hu), English-Ukrainian (En-Uk), English-Czech (En-Cs), English-Romanian (En-Ro), English-Bulgarian (En-Bg), English-Hindi (En-Hi), English-Malay (En-Ms), or the like), one or more high resource language pairs (e.g., English-Spanish, English-French, English-Italian, English-German, English-Chinese, or the like). A low resource language includes any language with a limited amount of available raw text data from various domains, limited lexical, semantic, or syntactic resources (e.g., dictionaries, or the like), smaller training sets, scarce parallel data, limited annotated or tagged text, or the like. A high resource language includes any language with large amounts of raw text data from various domains, many lexical, semantic, or syntactic resources (e.g., dictionaries, or the like), larger training sets, large collections of parallel data, readily available annotated or tagged text, or the like. In some embodiments, language pair parallel corpora 262 include data in one or more domains such as movie subtitles, tv subtitles, descriptive text, conversational dialogues, spoken language, weather data, medical data, legal data, news, or the like. In some embodiments, language pair parallel corpora 262 includes data derived from one or more text datasets or the like.

In some embodiments, language pair parallel corpora 262 includes one or more collections of parallel data composed of source sentence(s) 261 and the corresponding simplified version of each source sentence, such as back translation(s) 242, preprocessed sentence(s) 243, or the like. In some embodiments, the simplified version of each source sentence includes paraphrased text, lexically simpler variant of original text, syntactically simpler variant of original text, text with simpler sentence structure, text with reduced ambiguity, or the like. In some embodiments, language pair parallel corpora 262 includes reference simplification data for a given source sentence 261. Reference simplification data includes any text associated with good quality simplification of source sentence(s) 261, text associated with ideal or expected simplification of source sentence(s) 261, professional human simplification, or the like. In some embodiments, language pair parallel corpora 262 includes text that meets one or more predetermined threshold criteria based on one or more metrics associated with the quality of the simplification such as SARI (system output against references and against the normal sentence), BLEU (bilingual evaluation understudy), or the like.

Original translation(s) 264 includes text obtained by using black box machine translation system 210 to translate one or more source sentence(s) 261 from a source language (e.g., English or the like) to one or more target languages (e.g., French, Spanish, Portuguese, or the like). In some embodiments, black box machine translation system 210 generates, for a given source sentence 261, multiple original translation(s) 264 associated with multiple target languages, with each original translation corresponding to a target language.

In operation, during training, training engine 122 obtains, for translation into a target language, a set of source sentences 261 in a source language. Black box machine translation system 210 generates a back translation 242 for each ground truth translation(s) 244 associated with each source sentence in the set of source sentences 261. Filtering module 230 filters the set of back translations 242 associated with the set of source sentences 261 based on one or more metrics. Automatic preprocessing model 220 generates a preprocessed sentence 243 associated with each source sentence in the set of source sentences 261. Training engine 122 determines a loss function based on each preprocessed sentence 243 and the corresponding back translation 242 in the filtered set of back translations. Training engine 122 updates parameters of automatic preprocessing model 220 based on the loss function. Training engine 122 determines whether a threshold condition for the loss function has been achieved. When the threshold condition has been achieved, training engine 122 filters, using the filtering module 230, the set of preprocessed sentences based on one or more metrics. Details regarding this training process are provided below.

In various embodiments, source sentence(s) 261 includes any combination of one or more words, phrases, sentences, paragraphs, text strings, or the like in one or more domains such as movie subtitles, tv subtitles, descriptive text, conversational dialogues, spoken language, weather data, medical data, legal data, or the like. In some embodiments, source sentence(s) 261 includes one or more sentences derived from one or more text datasets, from a web-based program, from local storage on computing device 100, from a natural language generation software, or the like. In some embodiments, the training engine 122 selects source sentence(s) 261 in one or more domains or the like. In some embodiments, black box machine translation system 210 selects the source language based on ease of translation to a target language, similarity to a low resource language, or the like.

As an initial step in the training process, black box machine translation system 210 generates a back translation 242 for each ground truth translation 244 associated with each source sentence in a set of source sentences 261. In some embodiments, black box machine translation system 210 generates each back translation 242 by translating ground truth translation(s) 244 from one or more target languages (e.g., Welsh, Quechua, Swahili, Punjabi, or the like) to a source language (e.g., English or the like). In some embodiments, black box machine translation system 210 generates multiple back translations 242 by translating multiple ground truth translation(s) 244 associated with a given source sentence 261. In some embodiments, black box machine translation system 210 selects the one or more target languages based on ease of translation from the source language, similarity to the low resource language, or the like.

In some embodiments, training engine 122 generates back translations of target dataset Yⁱ for i=1 to M to language sᵢ given by T¹; T², . . . , T^{M} using black box machine translation model MTₜ_{_{i→s}}∀i. In the preceding equation, Yⁱ represents a dataset for a target language tᵢ, such as ground truth translation(s) 244; M represents the number of training language pairs; sᵢ represents the source language; T¹; T², . . . , T^{M} represents the back translations from each language in the set of target languages i to the source language, such as back translation(s) 242; and MTₜ_{_{i→s}}∀I represents the machine translation model used to translate each sentence from one or more target languages to the source language, such as black box machine translation system 210. In some embodiments, sᵢ is fixed to one language, such as English or the like.

Filtering module 230 filters the set of back translation(s) 242 associated with the set of source sentences 261 based on one or more metrics. In some embodiments, filtering module 230 is configured to compare text associated with back translation(s) 242 or the like to one or more reference texts (e.g., source sentence(s) 261, ground truth translation(s) 244, or the like). In some embodiments, filtering module 230 compares each back translation(s) 242 to multiple reference texts or the like. In another instance, filtering module 230 is configured to assign a score associated with the overall quality of the back translation(s) 242 based on one or more metrics associated with translation quality such as BLEU, NIST, METEOR, GLEU, WER, TER, ROUGE, or the like. In some embodiments, filtering module 230 is configured to assign a score to one or more segments of the back translation(s) 242, one or more n-grams included in the back translation(s) 242 (e.g., word sequences, or the like), alignment between one or more sequences in the back translation(s) 242 and the reference text, or the like. Filtering module 230 then determines a statistical measure such as mean values, standard deviation, range of values, median values, and/or the like based on the combination of the scores assigned to the one or more segments. In some embodiments, filtering module 230 filters out back translation(s) 242 that do not meet one or more predetermined threshold criteria based on the one or more metrics associated with translation quality or the like. In some embodiments, filtering module 230 filters back translation(s) 242 based on length, grammatical rules, or the like. In some embodiments, filtering module 230 includes a user interface that provides interactive functionality for receiving user input such as user assessment of translation quality or the like.

Automatic preprocessing model 220 generates a preprocessed sentence 243 associated with each source sentence in the set of source sentences 261. In some embodiments, automatic preprocessing model 220 preprocesses each source sentence(s) 261 and the corresponding back translation(s) 242 to obtain preprocessed sentence(s) 243. In some embodiments, training engine 122 trains a simplification model f_{APP} such as automatic preprocessing model 220, on the combined parallel corpus Uᵢ₌₁^{M}{(Xⁱ,Tⁱ)}. In the preceding equation, Uᵢ₌₁^{M} represents union of data for the set of languages i=1 to M, such as a union of source sentence(s) 261 and back translation(s) 242, Xⁱ represents a set sentences in one or more source languages i, such as source sentence(s) 261; and r represents the set of back translations generated from a set of target languages i, such as back translation(s) 242. In some embodiments, training engine 122 trains automatic preprocessing model 220 for one or more source languages associated with a low resource language pair, a high resource language pair, or the like.

To adjust the automatic preprocessing model 220 during training, training engine 122 determines a loss function based on the difference between each preprocessed sentence 243 and the corresponding back translation 242 in the filtered set of back translations. In some embodiments, training engine 122 determines a loss function based on the difference between each preprocessed sentence 243 and the corresponding source sentence(s) 261 or the like. In some embodiments, the loss function is associated with one or more metrics associated with quality of simplification of a text such as SARI, or the like. In some embodiments, training engine 122 computes the gradient of the loss function with respect to the parameters of the neural network comprising automatic preprocessing model 220, and updates the parameters by taking a step in a direction opposite to the gradient. In one instance, the magnitude of the step is determined by a training rate, which can be a constant rate (e.g., a step size of 0.001, or the like).

In some embodiment, training engine 122 trains automatic preprocessing model 220 using one or more hyperparameters. Each hyperparameter defines “higher-level” properties of automatic preprocessing model 220 instead of internal parameters of automatic preprocessing model 220 that are updated during training of automatic preprocessing model 220 and subsequently used to generate predictions, inferences, scores, and/or other output of automatic preprocessing model 220. Hyperparameters include a learning rate (e.g., a step size in gradient descent), a convergence parameter that controls the rate of convergence in a machine learning model, a model topology (e.g., the number of layers in a neural network or deep learning model), a number of training samples in training data for a machine learning model, a parameter-optimization technique (e.g., a formula and/or gradient descent technique used to update parameters of a machine learning model), a data-augmentation parameter that applies transformations to features inputted into automatic preprocessing model 220, a model type (e.g., neural network, clustering technique, regression model, support vector machine, tree-based model, ensemble model, etc.), or the like. In some embodiments, training engine 122 trains automatic preprocessing model 220 using hyper-parameters such as number of recurrent units, pre-trained word embeddings, dropout rate (e.g., 0.2), word representations of size (e.g., 512), feed forward layers with inner dimension (e.g., 4096), or the like.

Training engine 122 updates the parameters of automatic preprocessing model 220 based on the loss function. In some embodiments, training engine 122 updates the model parameters of automatic preprocessing model 220 at each training iteration to reduce the value of the cross-entropy loss between the generated preprocessed sentence 243 and the corresponding back translation 242 in the filtered set of back translations. In some embodiments, the update is performed by propagating the loss backwards through automatic preprocessing model 220 to adjust parameters of the model or weights on connections between neurons of the neural network.

Training engine 122 determines whether a threshold condition for the loss function has been achieved. In some embodiments, training engine 122 repeats the training process for multiple iterations until a threshold condition is achieved. In some embodiments, the threshold condition is achieved when the training process reaches convergence. For instance, convergence is reached when the cross-entropy loss changes very little or not at all with each iteration of the training process. In another instance, convergence is reached when the mean squared error for the loss function stays constant after a certain number of iterations. In some embodiments, the threshold condition is a predetermined value or range for the mean squared error associated with the loss function. In some embodiments, the threshold condition is a predetermined value or range for the error associated with one or more simplification quality metrics such as SARI, or the like. In some embodiments, the threshold condition is a certain number of iterations of the training process (e.g., 50 epochs, 800 epochs), a predetermined amount of time (e.g., 8 hours, 10 hours, 40 hours), or the like.

When the threshold condition has been achieved, training engine 122 filters, using the filtering module 230, the set of preprocessed sentences based on one or more metrics. In some embodiments, filtering module 230 is configured to compare text associated with preprocessed sentence(s) 243 or the like to one or more reference texts (e.g., source sentence(s) 261, back translation(s) 242, reference simplification data, or the like). In some embodiments, filtering module 230 compares each preprocessed sentence(s) 243 to multiple reference texts or the like. In another instance, filtering module 230 is configured to assign a score associated with the overall quality of the preprocessed sentence(s) 243 based on one or more metrics associated with quality of simplification of a text such as SARI, BLEU, or the like. In some embodiments, filtering module 230 is configured to assign a score to one or more segments of the preprocessed sentence(s) 243, one or more n-grams included in the preprocessed sentence(s) 243 (e.g., word sequences, or the like), alignment between one or more sequences in the preprocessed sentence(s) 243 and the reference text, or the like. Filtering module 230 then determines a statistical measure, such as mean values, standard deviation, range of values, median values, and/or the like based on the combination of the scores assigned to the one or more segments. In some embodiments, filtering module 230 filters out preprocessed sentence(s) 243 that do not meet one or more predetermined threshold criteria based on the one or more metrics associated with simplification quality or the like. In some embodiments, filtering module 230 filters preprocessed sentence(s) 243 based on length, grammatical rules, or the like. In some embodiments, filtering module 230 includes a user interface that provides interactive functionality for receiving user input such as user assessment of simplification quality or the like.

Testing engine 124 includes functionality to execute the trained automatic preprocessing model 220 output by training engine 122. Testing engine 124 applies the trained automatic preprocessing model 220 to preprocess one or more sentences prior to translation by black box machine translation system 210. Testing engine 124 includes, without limitation, black box machine translation system 210, automatic preprocessing model 220, filtering module 230, preprocessed sentence(s) 251, and preprocessed sentence translation(s) 252.

Preprocessed sentence(s) 251 includes text corresponding to a preprocessed version of source sentence(s) 261 generated using the trained automatic preprocessing model 220 output by training engine 122. In some embodiments, preprocessed sentence(s) 251 includes paraphrased text, lexically simpler variant of original text, syntactically simpler variant of original text, text with simpler sentence structure, text with reduced ambiguity, or the like corresponding to source sentence(s) 261. In some embodiments, during training, preprocessed sentence(s) 251 includes multiple simplifications for a given source sentence 261 or the like.

Preprocessed sentence translation(s) 252 includes text obtained by using black box machine translation system 210 to translate preprocessed sentence(s) 251 from a source language (e.g., English, French, Spanish, Portuguese, or the like) to a target language (e.g., Welsh, Quechua, Swahili, Punjabi, or the like). In some embodiments, black box machine translation system 210 generates, for a given preprocessed sentence(s) 251, multiple preprocessed sentence translation(s) 252 associated with multiple target languages, with each preprocessed sentence translation 252 corresponding to a target language.

In operation, testing engine 124 obtains, for translation into a target language, a source sentence 261 in a source language. The trained automatic preprocessing model 220 generates a preprocessed sentence 251 derived from the source sentence 261. Black box machine translation system 210 generates a translation of the preprocessed sentence into the target language. Testing engine 124 updates a language pair parallel corpora 262 based on the preprocessed sentence translation 252. Details regarding this testing process is are provided below.

Testing engine 124 obtains, for translation into a target language, a source sentence 261 in a source language. In some embodiments, a user selects the source sentence 261 from a web-based program, from local storage on computing device 100, from a natural language generation software, or the like. In some embodiments, the user inputs source sentence 261 using an interactive user interface or the like. In some embodiments, the user can select a whole sentence, a portion of a sentence, an aggregate of one or more portions of a text document, or the like.

Automatic preprocessing model 220 generates a preprocessed sentence 251 derived from the source sentence 261. In some embodiments, testing engine 124 preprocesses each source [symbol] for each test language pair j using the trained simplification model, such as automatic preprocessing model 220, to obtain the preprocessed sentence X^{j*} where X^{j*}=f^{APP} (X^{j}). In the preceding equation, X^{j*} represents the preprocessed sentence 251; X^{j} represents the source sentence 261; and f^{APP} represents automatic preprocessing model 220 for a particular source language.

Black box machine translation system 210 generates a translation of the preprocessed sentence into the target language. In some embodiments, testing engine 124 translates the simplified source using the black box machine translation model for the j^{th} test language pair as outlined in the following equation:

[symbol]

=MT_{s→t}_{ⱼ}(X^{j*}) (1)

In the above equation, [symbol] represents a translation of preprocessed sentence(s) 251, such as preprocessed sentence translation(s) 252; X^{j*} represents the preprocessed sentence 251; and MT_{s→t}_{ⱼ}(X^{j*}) represents the machine translation model used to translate each preprocessed sentence 251 from the source language to the target language, such as black box machine translation system 210.

Testing engine 124 updates a language pair parallel corpora 262 based on the preprocessed sentence translation 252. In some embodiments, testing engine 124 determines, using filtering module 230, a score associated with the overall quality of the preprocessed sentence translation 252 based on one or more metrics associated with translation quality such as BLEU, NIST, METEOR, GLEU, WER, TER, ROUGE, or the like. Testing engine 124 updates language pair parallel corpora 262 based on the preprocessed sentence translation 252 when the score assigned to preprocessed sentence(s) 251 meets one or more predetermined threshold criteria based on the one or more metrics associated with translation quality or the like.

In some embodiments, testing engine 124 updates language pair parallel corpora 262 based on the preprocessed sentence(s) 251. In some instances, testing engine 124 determines, using filtering module 230, a score associated with the overall quality of the preprocessed sentence(s) 251 based on one or more metrics associated with quality of simplification such as SARI, BLEU, or the like. Testing engine 124 updates language pair parallel corpora 262 based on the preprocessed sentence(s) 251 when the score assigned to preprocessed sentence(s) 251 meets one or more predetermined threshold criteria based on the one or more metrics associated with simplification quality or the like.

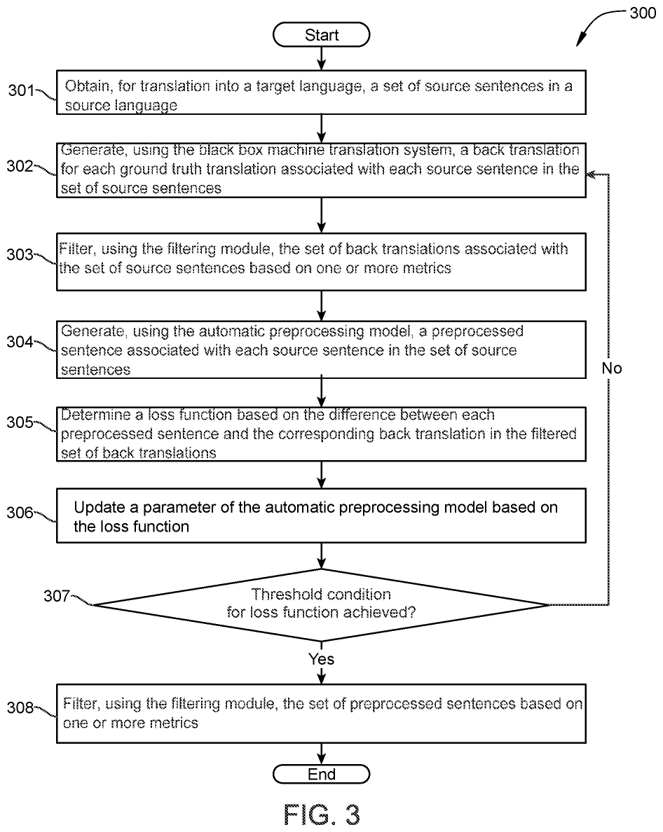

FIG. 3 is a flowchart of method steps for a sentence preprocessing procedure performed by the training engine and testing engine of FIG. 1, according to various embodiments of the present disclosure. Although the method steps are described in conjunction with the systems of FIGS. 1 and 2, persons skilled in the art will understand that any system configured to perform the method steps in any order falls within the scope of the present disclosure.

In step 301, training engine 122 obtains, for translation into a target language, a set of source sentences 261 in a source language. In various embodiments, source sentence(s) 261 source sentence(s) 261 includes any combination of one or more words, phrases, sentences, paragraphs, text strings, or the like in one or more domains such as descriptive text, conversational dialogues, spoken language, weather data, medical data, legal data, or the like. In some embodiments, source sentence(s) 261 includes one or more sentences derived from one or more text datasets, from a web-based program, from local storage on computing device 100, from a natural language generation software, or the like. In some embodiments, the training engine 122 selects source sentence(s) 261 in a user-specified domain, a combination of multiple domains, or the like. In some embodiments, black box machine translation system 210 selects the source language based on ease of translation to a target language, similarity to a low resource language, or the like.

In step 302, training engine 122 generates, using the black box machine translation system 210, a back translation 242 for each ground truth translation 244 associated with each source sentence in the set of source sentences 261. In some embodiments, black box machine translation system 210 generates each back translation 242 by translating ground truth translation(s) 244 from target language to source language (e.g., English or the like). In some embodiments, black box machine translation system 210 generates multiple back translation(s) 242 by translating multiple ground truth translation(s) 244 associated with a given source sentence 261. In some embodiments, black box machine translation system 210 generates each back translation 242 by translating any translation (e.g., original translation(s) 264) of one or more high-resource target languages or the like.

In step 303, training engine 122 filters, using filtering module 230, the set of back translation(s) 242 associated with the set of source sentences 261 based on one or more metrics. In another instance, filtering module 230 is configured to assign a score associated with the overall quality of the back translation(s) 242 based on one or more metrics associated with translation quality such as BLEU, NIST, METEOR, GLEU, WER, TER, ROUGE, or the like. In some embodiments, filtering module 230 filters out back translation(s) 242 that do not meet one or more predetermined threshold criteria based on the one or more metrics associated with translation quality or the like. In some embodiments, filtering module 230 filters back translation(s) 242 based on length, grammatical rules, language model score, or the like. In some embodiments, filtering module 230 includes a user interface that provides interactive functionality for receiving user input such as user assessment of translation quality or the like.

In step 304, training engine 122 generates, using automatic preprocessing model 220, a preprocessed sentence 243 associated with each source sentence in the set of source sentences 261. In some embodiments, automatic preprocessing model 220 preprocesses each source sentence(s) 261 and the corresponding back translation(s) 242 to obtain preprocessed sentence(s) 243. In some embodiments, training engine 122 trains automatic preprocessing model 220 for one or more source languages associated with a low resource language pair, a high resource language pair, or the like.

In step 305, training engine 122 determines a loss function based on the difference between each preprocessed sentence 243 and the corresponding back translation in the filtered set of back translations 242. In some embodiments, training engine 122 determines a loss function based on the difference between each preprocessed sentence 243 and the corresponding source sentence(s) 261 or the like. In some embodiments, the loss function is associated with one or more metrics associated with quality of simplification of a text such as SARI, or the like. In some embodiments, training engine 122 computes the gradient of the loss function with respect to the parameters of the neural network comprising automatic preprocessing model 220, and updates the parameters by taking a step in a direction opposite to the gradient.

In step 306, training engine 122 updates parameters of the automatic preprocessing model based on the loss function. In some embodiments, training engine 122 updates the model parameters of automatic preprocessing model 220 at each training iteration to reduce the value of the mean squared error for the loss function. In some embodiments, the update is performed by propagating the loss backwards through automatic preprocessing model 220 to adjust parameters of the model or weights on connections between neurons of the neural network.

In step 307, training engine 122 determines whether a threshold condition for the loss function has been achieved. In some embodiments, the threshold condition is achieved when the training process reaches convergence. In some embodiments, the threshold condition is a predetermined value or range for the mean squared error associated with the loss function. In some embodiments, the threshold condition is a predetermined value or range for the error associated with one or more simplification quality metrics such as SARI, or the like. In some embodiments, the threshold condition is a certain number of iterations of the training process (e.g., 50 epochs, 800 epochs), a predetermined amount of time (e.g., 8 hours, 10 hours, 40 hours), or the like.

When the threshold condition is achieved, the training engine 122 advances the sentence preprocessing procedure to step 308. When the threshold condition has not been achieved, the training engine 122 repeats a portion of the sentence preprocessing procedure beginning with step 302.

In step 308, training engine 122 filters, using filtering module 230, the set of preprocessed sentences based on one or more metrics. In some embodiments, filtering module 230 filters out preprocessed sentence(s) 243 that do not meet one or more predetermined threshold criteria based on the one or more metrics associated with simplification quality or the like. In some embodiments, filtering module 230 filters preprocessed sentence(s) 243 based on length, grammatical rules, or the like. In some embodiments, filtering module 230 includes a user interface that provides interactive functionality for receiving user input such as user assessment of simplification quality or the like.

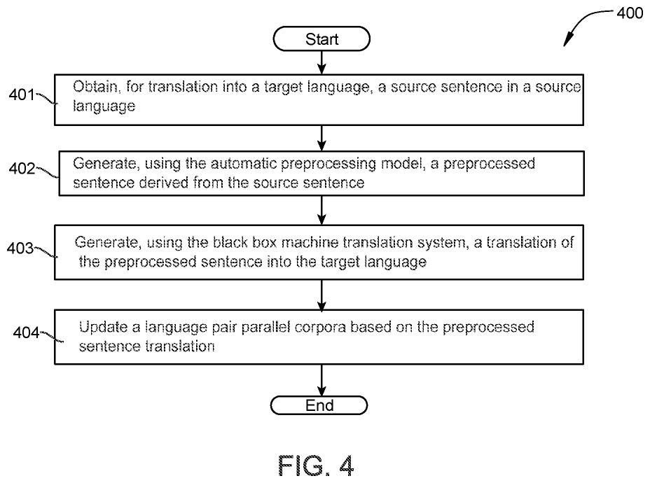

FIG. 4 is a flowchart of method steps for a sentence translation procedure, according to various embodiments of the present disclosure. Although the method steps are described in conjunction with the systems of FIGS. 1 and 2, persons skilled in the art will understand that any system configured to perform the method steps in any order falls within the scope of the present disclosure.

In step 401, testing engine 124 obtains, for translation into a target language, a source sentence 261 in a source language. In some embodiments, a user selects the source sentence 261 from a web-based program, from local storage on computing device 100, from a natural language generation software, or the like. In some embodiments, the user inputs source sentence 261 using an interactive user interface or the like. In some embodiments, the user can select a whole sentence, a portion of a sentence, an aggregate of one or more portions of a text document, or the like.

In step 402, testing engine 124 generates, using automatic preprocessing model 220, a preprocessed sentence 251 derived from the source sentence 261. In some embodiments, automatic preprocessing model 220 uses black box machine translation system 210 to generate a back translation 242, and then preprocesses the source sentence 261 and the back translation 242 to obtain preprocessed sentence 251.

In step 403, testing engine 124 generates, using black box machine translation system 210, a translation of the preprocessed sentence 251 into the target language. In some embodiments, black box machine translation system 210 translates preprocessed sentence 251 into multiple preprocessed sentence translations 252 associated with multiple target languages.

In optional step 404, testing engine 124 updates language pair parallel corpora 262 based on the preprocessed sentence translation 252. In some embodiments, testing engine 124 determines, using filtering module 230, a score associated with the overall quality of the preprocessed sentence translation 252 based on one or more metrics associated with translation quality such as BLEU, NIST, METEOR, GLEU, WER, TER, ROUGE, or the like. In some embodiments, testing engine 124 updates language pair parallel corpora 262 based on the preprocessed sentence translation 252 when the score assigned to preprocessed sentence(s) 251 meets one or more predetermined threshold criteria based on the one or more metrics associated with translation quality or the like. In some embodiments, testing engine 124 updates language pair parallel corpora 262 by correcting the original sentence pair translation using the preprocessed sentence translation 252. In some embodiments, testing engine 124 updates language pair parallel corpora 262 by adding a new sentence pair translation corresponding to the preprocessed sentence translation 252.

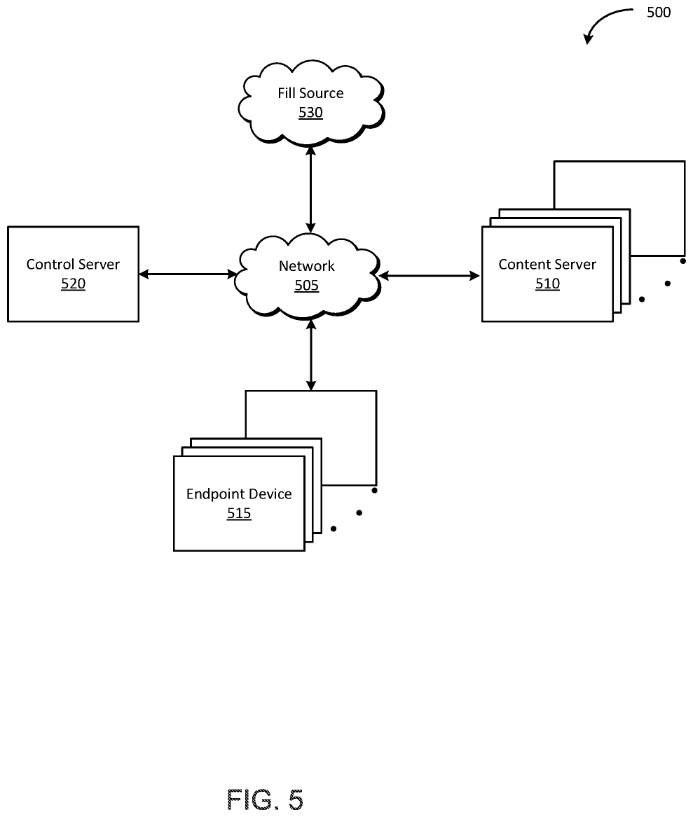

FIG. 5 illustrates a network infrastructure 500 used to distribute content to content servers 510 and endpoint devices 515, according to various embodiments of the invention. As shown, the network infrastructure 500 includes content servers 510, control server 520, and endpoint devices 515, each of which are connected via a network 505.

Each endpoint device 515 communicates with one or more content servers 510 (also referred to as “caches” or “nodes”) via the network 505 to download content, such as textual data, graphical data, audio data, video data, and other types of data. The downloadable content, also referred to herein as a “file,” is then presented to a user of one or more endpoint devices 515. In various embodiments, the endpoint devices 515 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 510 may include a web-server, database, and server application 617 configured to communicate with the control server 520 to determine the location and availability of various files that are tracked and managed by the control server 520. Each content server 510 may further communicate with a fill source 530 and one or more other content servers 510 in order “fill” each content server 510 with copies of various files. In addition, content servers 510 may respond to requests for files received from endpoint devices 515. The files may then be distributed from the content server 510 or via a broader content distribution network. In some embodiments, the content servers 510 enable users to authenticate (e.g., using a username and password) in order to access files stored on the content servers 510. Although only a single control server 520 is shown in FIG. 5, in various embodiments multiple control servers 520 may be implemented to track and manage files.

In various embodiments, the fill source 530 may include an online storage service (e.g., Amazon® Simple Storage Service, Google® Cloud Storage, etc.) in which a catalog of files, including thousands or millions of files, is stored and accessed in order to fill the content servers 510. Although only a single fill source 530 is shown in FIG. 5, in various embodiments multiple fill sources 530 may be implemented to service requests for files. Further, as is well-understood, any cloud-based services can be included in the architecture of FIG. 5 beyond fill source 530 to the extent desired or necessary.

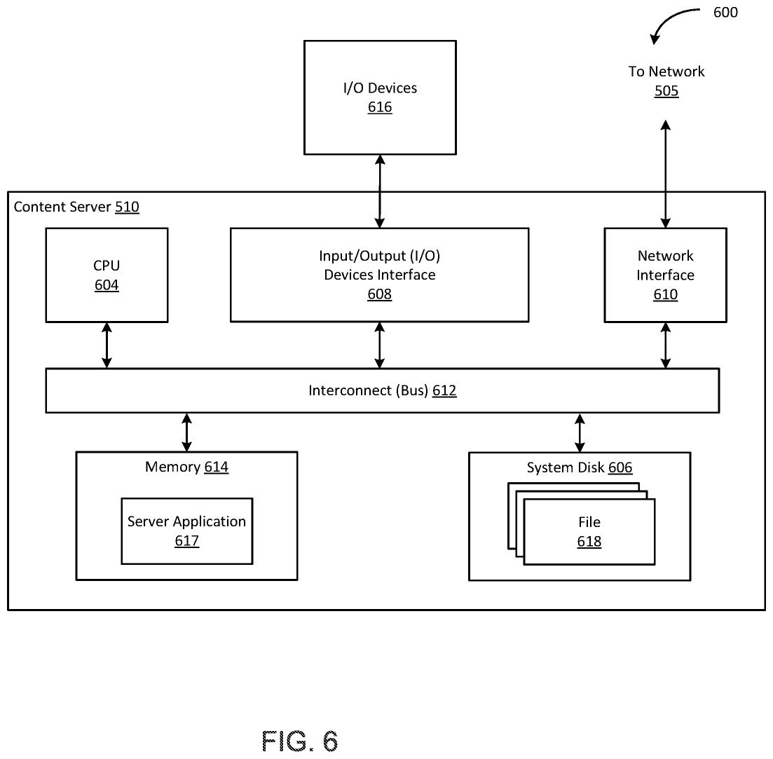

FIG. 6 is a block diagram of a content server 510 that may be implemented in conjunction with the network infrastructure 500 of FIG. 5, according to various embodiments of the present invention. As shown, the content server 510 includes, without limitation, a central processing unit (CPU) 604, a system disk 606, an input/output (I/O) devices interface 608, a network interface 610, an interconnect 612, and a system memory 614.

The CPU 604 is configured to retrieve and execute programming instructions, such as server application 617, stored in the system memory 614. Similarly, the CPU 604 is configured to store application data (e.g., software libraries) and retrieve application data from the system memory 614. The interconnect 612 is configured to facilitate transmission of data, such as programming instructions and application data, between the CPU 604, the system disk 606, I/O devices interface 608, the network interface 610, and the system memory 614. The I/O devices interface 608 is configured to receive input data from I/O devices 616 and transmit the input data to the CPU 604 via the interconnect 612. For example, I/O devices 616 may include one or more buttons, a keyboard, a mouse, and/or other input devices. The I/O devices interface 608 is further configured to receive output data from the CPU 604 via the interconnect 612 and transmit the output data to the I/O devices 616.

The system disk 606 may include one or more hard disk drives, solid state storage devices, or similar storage devices. The system disk 606 is configured to store non-volatile data such as files 618 (e.g., audio files, video files, subtitles, application files, software libraries, etc.). The files 618 can then be retrieved by one or more endpoint devices 515 via the network 505. In some embodiments, the network interface 610 is configured to operate in compliance with the Ethernet standard.

The system memory 614 includes a server application 617 configured to service requests for files 618 received from endpoint device 515 and other content servers 510. When the server application 617 receives a request for a file 618, the server application 617 retrieves the corresponding file 618 from the system disk 606 and transmits the file 618 to an endpoint device 515 or a content server 510 via the network 505.

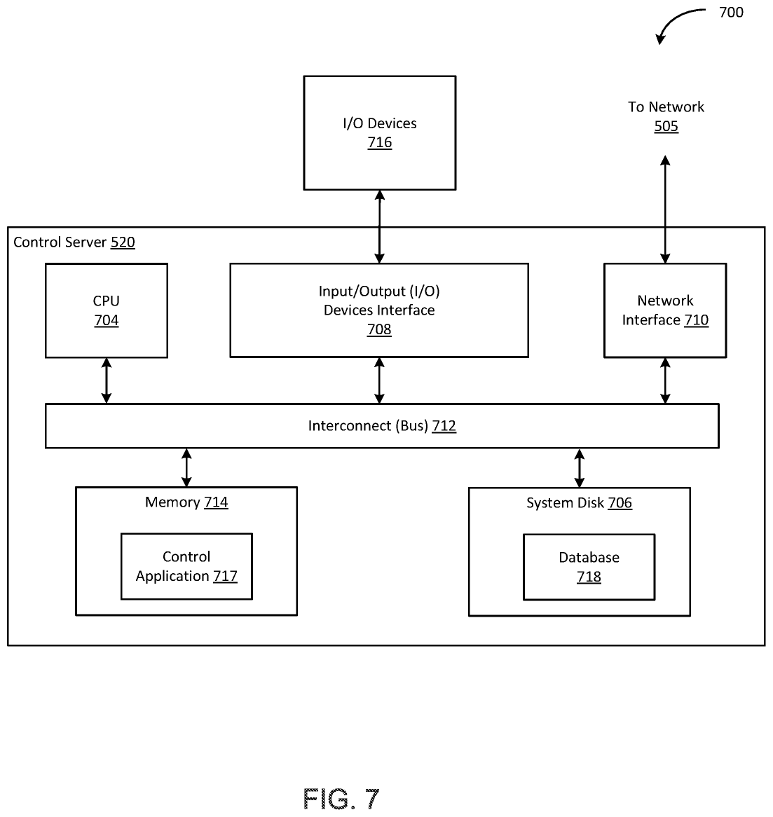

FIG. 7 is a block diagram of a control server 520 that may be implemented in conjunction with the network infrastructure 500 of FIG. 5, according to various embodiments of the present invention. As shown, the control server 520 includes, without limitation, a central processing unit (CPU) 704, a system disk 706, an input/output (I/O) devices interface 708, a network interface 710, an interconnect 712, and a system memory 714.

The CPU 704 is configured to retrieve and execute programming instructions, such as control application 717, stored in the system memory 714. Similarly, the CPU 704 is configured to store application data (e.g., software libraries) and retrieve application data from the system memory 714 and a database 718 stored in the system disk 706. The interconnect 712 is configured to facilitate transmission of data between the CPU 704, the system disk 706, I/O devices interface 708, the network interface 710, and the system memory 714. The I/O devices interface 708 is configured to transmit input data and output data between the I/O devices 716 and the CPU 704 via the interconnect 712. The system disk 706 may include one or more hard disk drives, solid state storage devices, and the like. The system disk 706 is configured to store a database 718 of information associated with the content servers 510, the fill source(s) 530, and the files 618.

The system memory 714 includes a control application 717 configured to access information stored in the database 718 and process the information to determine the manner in which specific files 618 will be replicated across content servers 510 included in the network infrastructure 500. The control application 717 may further be configured to receive and analyze performance characteristics associated with one or more of the content servers 510 and/or endpoint devices 515.

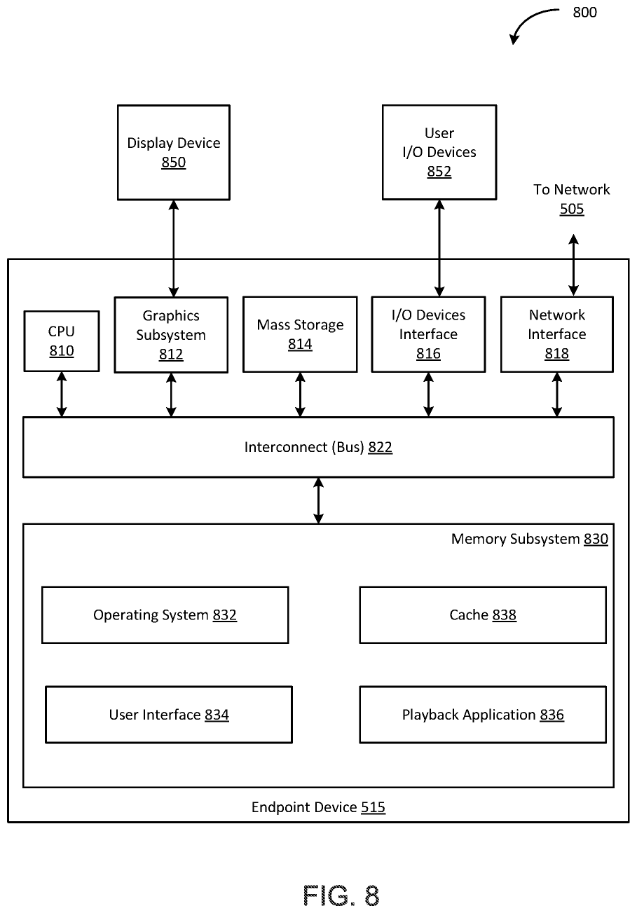

FIG. 8 is a block diagram of an endpoint device 515 that may be implemented in conjunction with the network infrastructure 500 of FIG. 5, according to various embodiments of the present invention. As shown, the endpoint device 515 may include, without limitation, a CPU 810, a graphics subsystem 812, an I/O device interface 814, a mass storage unit 816, a network interface 818, an interconnect 822, and a memory subsystem 830.

In some embodiments, the CPU 810 is configured to retrieve and execute programming instructions stored in the memory subsystem 830. Similarly, the CPU 810 is configured to store and retrieve application data (e.g., software libraries) residing in the memory subsystem 830. The interconnect 822 is configured to facilitate transmission of data, such as programming instructions and application data, between the CPU 810, graphics subsystem 812, I/O devices interface 814, mass storage unit 816, network interface 818, and memory subsystem 830.

In some embodiments, the graphics subsystem 812 is configured to generate frames of video data and transmit the frames of video data to display device 850. In some embodiments, the graphics subsystem 812 may be integrated into an integrated circuit, along with the CPU 810. The display device 850 may comprise any technically feasible means for generating an image for display. For example, the display device 850 may be fabricated using liquid crystal display (LCD) technology, cathode-ray technology, and light-emitting diode (LED) display technology. An input/output (I/O) device interface 814 is configured to receive input data from user I/O devices 852 and transmit the input data to the CPU 810 via the interconnect 822. For example, user I/O devices 852 may comprise one of more buttons, a keyboard, and a mouse or other pointing device. The I/O device interface 814 also includes an audio output unit configured to generate an electrical audio output signal. User I/O devices 852 includes a speaker configured to generate an acoustic output in response to the electrical audio output signal. In alternative embodiments, the display device 850 may include the speaker. A television is an example of a device known in the art that can display video frames and generate an acoustic output.

A mass storage unit 816, such as a hard disk drive or flash memory storage drive, is configured to store non-volatile data. A network interface 818 is configured to transmit and receive packets of data via the network 505. In some embodiments, the network interface 818 is configured to communicate using the well-known Ethernet standard. The network interface 818 is coupled to the CPU 810 via the interconnect 822.

In some embodiments, the memory subsystem 830 includes programming instructions and application data that comprise an operating system 832, a user interface 834, and a playback application 836. The operating system 832 performs system management functions such as managing hardware devices including the network interface 818, mass storage unit 816, I/O device interface 814, and graphics subsystem 812. The operating system 832 also provides process and memory management models for the user interface 434 and the playback application 836. The user interface 834, such as a window and object metaphor, provides a mechanism for user interaction with endpoint device 515. Persons skilled in the art will recognize the various operating systems and user interfaces that are well-known in the art and suitable for incorporation into the endpoint device 515.

In some embodiments, the playback application 836 is configured to request and receive content from the content server 510 via the network interface 818. Further, the playback application 836 is configured to interpret the content and present the content via display device 850 and/or user I/O devices 852.

In sum, training engine 122 obtains, for translation into a target language, a set of source sentences 261 in a source language. Black box machine translation system 210 generates a back translation 242 for each ground truth translation 244 associated with each source sentence in the set of source sentences 261. Filtering module 230 filters the set of back translations 242 associated with the set of source sentences 261 based on one or more metrics. Automatic preprocessing model 220 generates a preprocessed sentence 243 associated with each source sentence in the set of source sentences 261. Training engine 122 determines a loss function based on each preprocessed sentence 243 and the corresponding back translation 242 in the filtered set of back translations. Training engine 122 updates parameters of automatic preprocessing model 220 based on the loss function. Training engine 122 determines whether a threshold condition for the loss function has been achieved. When the threshold condition has been achieved, training engine 122 filters, using the filtering module 230, the set of preprocessed sentences based on one or more metrics.

Testing engine 124 obtains, for translation into a target language, a source sentence 261 in a source language. The trained automatic preprocessing model 220 generates a preprocessed sentence 251 derived from the source sentence 261. Black box machine translation system 210 generates a translation of the preprocessed sentence into the target language. Testing engine 124 updates a language pair parallel corpora 262 based on the preprocessed sentence translation 252.

Disclosed techniques allow for easily adapting a simplification model to a new domain by efficiently generating training data that includes large-scale parallel corpora based on back translations derived from high resource language pairs. The trained simplification model achieves improved performance in simplifying complex idiomatic and non-compositional phrases in low resource language pairs prior to translation by black box machine translation systems, thereby resulting in improved translation performance for low resource language pairs while preserving the meaning of the original sentences.

1. In some embodiments, a computer-implemented method for training a sentence preprocessing model comprises: determining, using a machine translation system, a back translation associated with a ground truth translation of a source sentence in a source language to a target language, wherein the back translation comprises a translation of the ground truth translation from one or more target languages to the source language; determining, using the sentence preprocessing model, a simplified sentence associated with the source sentence; and updating one or more parameters of the sentence preprocessing model based on the simplified sentence and the back translation.

2. The computer-implemented method of clause 1, further comprising: determining a loss function based on the simplified sentence and the back translation; and determining, based on the loss function, whether a threshold condition is achieved.

3. The computer-implemented method of clauses 1 or 2, further comprising: determining, using the machine translation system, a translation of the simplified sentence into the target language.

4. The computer-implemented method of any of clauses 1-3, further comprising: assigning, based on one or more metrics, a score to the back translation.

5. The computer-implemented method of any of clauses 1-4, wherein the one or more metrics include at least one of BLEU, NIST, METEOR, GLEU, WER, TER, or ROUGE.

6. The computer-implemented method of any of clauses 1-5, wherein the score is based on a comparison between the back translation and the ground truth translation.

7. The computer-implemented method of any of clauses 1-6, further comprising: assigning, based on one or more metrics, a score to the simplified sentence.

8. The computer-implemented method of any of clauses 1-7, wherein the one or more metrics include at least one of: SARI or BLEU.

9. The computer-implemented method of any of clauses 1-8, wherein the score is based on a comparison between the simplified sentence and reference simplification data.

10. The computer-implemented method of any of clauses 1-9, wherein the target language is selected based on at least one of: ease of translation from the source language, or similarity to a low resource language.

11. In some embodiments, one or more non-transitory computer readable media store instructions that, when executed by one or more processors, cause the one or more processors to perform the steps of: determining, using a machine translation system, a back translation associated with a ground truth translation of a source sentence in a source language to a target language, wherein the back translation comprises a translation of the ground truth translation from one or more target languages to the source language; determining, using the sentence preprocessing model, a simplified sentence associated with the source sentence; and updating one or more parameters of the sentence preprocessing model based on the simplified sentence and the back translation.

12. The one or more non-transitory computer readable media of clause 11, further comprising: determining a loss function based on the simplified sentence and the back translation; and determining, based on the loss function, whether a threshold condition is achieved.

13. The one or more non-transitory computer readable media of clauses 11 or 12, further comprising: determining, using the machine translation system, a translation of the simplified sentence into the target language.

14. The one or more non-transitory computer readable media of any of clauses 11-13, further comprising: assigning, based on one or more metrics, a score to the back translation.

15. The one or more non-transitory computer readable media of any of clauses 11-14, wherein the one or more metrics include at least one of BLEU, NIST, METEOR, GLEU, WER, TER, or ROUGE.

16. The one or more non-transitory computer readable media of any of clauses 11-15, wherein the score is based on a comparison between the back translation and the ground truth translation.

17. The one or more non-transitory computer readable media of any of clauses 11-16, further comprising: assigning, based on one or more metrics, a score to the simplified sentence.

18. The one or more non-transitory computer readable media of any of clauses 11-17, wherein the one or more metrics include at least one of: SARI or BLEU.

19. The one or more non-transitory computer readable media of any of clauses 11-18, wherein the target language is selected based on at least one of: ease of translation from the source language, or similarity to a low resource language.

20. In some embodiments, a system comprises: a memory storing one or more software applications; and a processor that, when executing the one or more software applications, is configured to perform the steps of: determining, using a machine translation system, a back translation associated with a ground truth translation of a source sentence in a source language to a target language, wherein the back translation comprises a translation of the ground truth translation from one or more target languages to the source language; determining, using the sentence preprocessing model, a simplified sentence associated with the source sentence; and updating one or more parameters of the sentence preprocessing model based on the simplified sentence and the back translation.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a sentence preprocessing model, the method comprising:
determining, using a machine translation system, a back translation associated with a ground truth translation of a source sentence in a source language to a target language, wherein the back translation comprises a translation of the ground truth translation from one or more target languages to the source language;
determining, using the sentence preprocessing model, a simplified sentence associated with the source sentence; and
updating one or more parameters of the sentence preprocessing model based on the simplified sentence and the back translation.

2. The computer-implemented method of claim 1, further comprising:
determining a loss function based on the simplified sentence and the back translation; and
determining, based on the loss function, whether a threshold condition is achieved.

3. The computer-implemented method of claim 1, further comprising:
determining, using the machine translation system, a translation of the simplified sentence into the target language.

4. The computer-implemented method of claim 1, further comprising:
assigning, based on one or more metrics, a score to the back translation.

5. The computer-implemented method of claim 4, wherein the one or more metrics include at least one of BLEU, NIST, METEOR, GLEU, WER, TER, or ROUGE.

6. The computer-implemented method of claim 4, wherein the score is based on a comparison between the back translation and the ground truth translation.

7. The computer-implemented method of claim 1, further comprising:
assigning, based on one or more metrics, a score to the simplified sentence.

8. The computer-implemented method of claim 7, wherein the one or more metrics include at least one of: SARI or BLEU.

9. The computer-implemented method of claim 7, wherein the score is based on a comparison between the simplified sentence and reference simplification data.

10. The computer-implemented method of claim 1, wherein the target language is selected based on at least one of: ease of translation from the source language, or similarity to a low resource language.

11. One or more non-transitory computer readable media storing instructions that, when executed by one or more processors, cause the one or more processors to perform the steps of:
determining, using a machine translation system, a back translation associated with a ground truth translation of a source sentence in a source language to a target language, wherein the back translation comprises a translation of the ground truth translation from one or more target languages to the source language;
determining, using the sentence preprocessing model, a simplified sentence associated with the source sentence; and
updating one or more parameters of the sentence preprocessing model based on the simplified sentence and the back translation.

12. The one or more non-transitory computer readable media of claim 11, further comprising:
determining a loss function based on the simplified sentence and the back translation; and
determining, based on the loss function, whether a threshold condition is achieved.

13. The one or more non-transitory computer readable media of claim 11, further comprising:
determining, using the machine translation system, a translation of the simplified sentence into the target language.

14. The one or more non-transitory computer readable media of claim 11, further comprising:
assigning, based on one or more metrics, a score to the back translation.

15. The one or more non-transitory computer readable media of claim 14, wherein the one or more metrics include at least one of BLEU, NIST, METEOR, GLEU, WER, TER, or ROUGE.

16. The one or more non-transitory computer readable media of claim 14, wherein the score is based on a comparison between the back translation and the ground truth translation.

17. The one or more non-transitory computer readable media of claim 11, further comprising:
assigning, based on one or more metrics, a score to the simplified sentence.

18. The one or more non-transitory computer readable media of claim 17, wherein the one or more metrics include at least one of: SARI or BLEU.

19. The one or more non-transitory computer readable media of claim 11, wherein the target language is selected based on at least one of: ease of translation from the source language, or similarity to a low resource language.

20. A system, comprising:
a memory storing one or more software applications; and
a processor that, when executing the one or more software applications, is configured to perform the steps of:
determining, using a machine translation system, a back translation associated with a ground truth translation of a source sentence in a source language to a target language, wherein the back translation comprises a translation of the ground truth translation from one or more target languages to the source language;
determining, using the sentence preprocessing model, a simplified sentence associated with the source sentence; and
updating one or more parameters of the sentence preprocessing model based on the simplified sentence and the back translation.
